(19) United States
(12) Patent Application Publication
(10) Pub. No.: US 2008/0253292 A1
(43) Pub. Date: Oct. 16, 2008

(54) Method and Device For Controlling Network Elements in a Decentralized Network

(76) Inventors: Jens-Uwe Busser, Munchen (DE); Gerald Liebe, Strausberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/883,461

(22) PCT Filed: Jan. 30, 2006
(86) PCT No.: PCT/EP06/50534

§ 371 Date: Mar. 26, 2008

(30) Foreign Application Priority Data
Feb. 1, 2005 (DE) 10 2005 004 611.8

(51) Int. Cl. H04L 12/24

(52) U.S. Cl. 370/241

(57) ABSTRACT

In decentralized networks such as, for example, peer-to-peer networks, services are not furnished by centralized units, but between the network elements. These also carry out access controls and notify the centralized servers of charge registrations of the services utilized. By suitable valid or invalid inquiry messages, it is monitored by using random sampling, whether the peers fulfill their tasks with regard to charge registration and access controls.

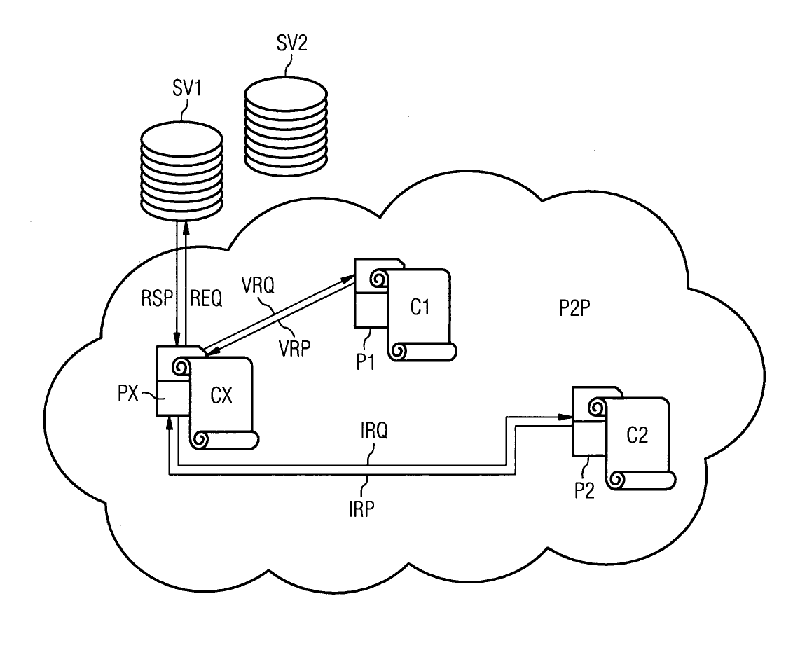

There are decentralized networks known from prior art in which a predominant proportion of connected network elements provide functions and services to other network elements while also being able to use functions and services provided by other network elements, without a centralized controlling instance having to be provided for such purposes. In other words a given network element may at times play the role of server to another network element, while at other times it may assume the role of client to the other network element. In order to distinguish this situation from a conventional client-server classification, a network element connected to such a decentralized network is often also known as a peer. Decentralized networks of this kind are therefore also known as peer-to-peer networks, or P2P networks for short.

In general the conceptual classification of a decentralized network does not exclude the existence of centralized instances. Even mixed forms of network, in which certain tasks are transferred to a centralized instance or server, are referred to as decentralized networks or P2P networks, provided said networks do not include any server through which any kind of communication relationship between two network elements must be conducted.

In decentralized networks, services are not furnished by centralized instances, but between individual network elements. The network elements carry out for example access controls and notify centralized servers of the charge registrations of services utilized, or compute these for themselves.

A decentralized network organized on the principle of distributed hash tables (DHTs), in which resources are available on a decentralized basis, will be discussed below by way of example. In this case the term resource includes data of all kinds, such as information, files, services etc. A hash function is used to construct the distributed hash tables. Applying this hash function to a resource or a key concept delivers a unique hash value, or index value, for indexing the resource.

A further indexing method for mapping resources on numerical index values delivers what is known as the SQUID algorithm, based on the use of space filling curves (SFCs).

In a network of the kind mentioned, resources are stored in a decentralized manner on those network elements in which the P2P address, that is to say, for example, the hash value formed from the IP address (Internet Protocol) and port number of the network element, best matches the index value of the resource (such as the hash value of a search term etc.).

The network elements in said decentralized network use digital signatures and certificates to authenticate themselves and the data exchanges they initiate. These certificates are issued in advance by a trustworthy, centralized certification authority (CA) and included as a resource in the decentralized network.

A method for including certificates in a decentralized network was proposed in the application submitted to the German Patent and Trade Mark Office on Jan. 29, 2004, application number 10 2004 004 606.9, under the title “Circuit arrangement and method for securing communication within communication networks”, which is advantageously distinguished in that among other things no servers are required in order to make issued and stored certificates available while operating. The existence of a valid certificate also serves as proof of authorization granted by the certification authority to authorized network elements. An example of an authorized network element is a computer system used by a paying customer.

A method for the revocation of certificates was proposed in the application submitted to the European Patent Office on Aug. 12, 2004, application number 04019230.4, under the title “Method for ensuring authenticity and/or confidentiality in a P2P network”. The method proposed therein is distinguished in that it provides certificate revocation lists as resources in a decentralized network.

If the intention is for example to contribute data such as the user profile of a network element or messages to absent network elements as resources in the decentralized network, said data must be digitally signed by the network element which creates them. For this purpose the network element computes an index value (for example a hash value) for said data, then signs said data with a private key corresponding to the public key from the certificate of the network element. This not only protects integrity, but also ensures that only authorized and authenticated network elements can store data in the decentralized network.

Said data set can also be transmitted to a collection point for billing purposes. A method for recording billing data was proposed in the application submitted to the German Patent and Trade Mark Office on Aug. 23, 2004, application number 10 2004 040 766.5, under the title “Method and arrangement for billing in a decentralized network”.

If a network element wishes to receive certain resources, such as an external user profile or messages stored on its behalf etc., from another network element, it must create a signed request in order to prove its authorization and authenticity. This request can likewise be used for billing purposes. By this means it is possible to carry out network access control alongside billing based on usage.

However, one disadvantage of such a decentralized architecture is that decentralized network elements can be manipulated. Manipulation is easily carried out, in particular in the case of purely software-based peers, by examining and modifying the machine-readable instructions in the software, or “reverse engineering”. Certain feasible malicious manipulations are illustrated below:
1. Swapping out a root certificate from the certification authority: This manipulation enables users with peer software that has been correspondingly manipulated to configure their own parallel network. Communication with the original network is then no longer possible. From the data exchange point of view, this parallel network is scarcely distinguishable from a “legal” network when manipulated peer software is used. A provider of legal peer software, by using a network element on which it is known that manipulated peer software is being run with a swapped root certificate, could find further network elements that are using manipulated peer software and take legal action against their users. To discover further sources of manipulated peer software, the provider could look for a download site offering manipulated software.
2. Deactivating or working around billing functions: The peer continues to make its data and services available to third parties, but either does not generate or does not forward any billing information.
3. Deactivating or working around access control functions: A peer makes services available to third parties without checking their authorization, that is, without exercising any network access control, even though said third parties are not authorized to receive said services in the circumstances concerned.
4. Deactivating or working around logging functions: A peer cancels the reporting or forwarding of alarm and logging information when it receives invalid queries or other problems occur. Switching off logging functions does not of itself have an adverse effect on the network, but can be a preparatory step to further manipulations. The automatic detection of peer software that has been manipulated in this regard is costly and time-consuming, since the entire data exchange of a network element would have to be logged.

Of itself, deactivating or working around billing functions (point 2 above) and/or access control functions (point 3) on one's own network element confers no intrinsic benefit on the user of said network element. However, if increasing numbers of users make use of peer software that has been manipulated in such a way, billing and access control are gradually put out of action. The prevention of such manipulated peer software is therefore in the legitimate interests of the peer-to-peer network operator. It is therefore advisable, despite the considerable effort, to search the decentralized network for network elements using manipulated peer software, and then to revoke their certificates and take appropriate measures against their users.

A common feature of all disclosed countermeasures against manipulated software is that they can be put into practice on an ad hoc basis only and involve the intensive use of investigative personnel. Automated countermeasures against the use of unauthorized peer-to-peer software are not known in the prior art at present.

The object of the invention is therefore to specify improved means of carrying out countermeasures against the use of manipulated peer-to-peer software and at the same time to avoid the disadvantages known from the prior art.

With respect to the method aspect, this object is achieved in a communication system having the features mentioned in claim 1, with the aid of a method having the features mentioned in said claim, and with respect to the device aspect, with the aid of a network element having the features mentioned in claim 14. The object is further achieved by means of a computer program product having the features of claim 15.

The inventive method for checking network elements in a decentralized network, in which at least a first part of the network elements provides at least temporarily a service for at least a second part of the network elements, envisions a first step in which a first network element selects a second network element to be checked. The first network element, as understood within the known peer-to-peer task distribution, can be a network element operating normally in all other respects, or else a dedicated check peer charged with the task of checking other network elements or peers on, for example, a cyclic basis. The second network element is the network element that is to be checked. The second network element may be chosen for example according to a cyclic checking plan, or by processing a list containing network elements operating in a suspicious manner (black list), or even by random sampling. In fact the selection may be made on the basis of any convenient criterion. A second step in the method involves defining parameters to be assigned to a request message. These can be simulated parameters, for example a predetermined sender address, or alias address, of the first network element, which is intended for checking purposes and need not necessarily match the actual sender address of the first network element. Further parameters include for example a certificate, a request signature, a time stamp etc. In a further step in the method, the request message defined in the above way is transmitted to the second network element, and in a final step in the method the at least one response message which answered the request message is analyzed.

One obvious important advantageous of the inventive method is that the inventively proposed automated analysis by means of request and response messages does away with the need for the time-consuming and labor-intensive ad hoc measures using onsite inspection of manipulated peer-to-peer software.

Since the checks can be performed by a peer operating in all other respects within the usual procedures and hierarchy, this advantageously means it is unnecessary to modify the network architecture or to intervene further in the software of other network elements in order to implement the inventive method.

Advantageous embodiments of the invention are specified in the individual subclaims.

Advantageously an analysis is performed with the aid of the parameters previously stored in the first network element and the parameters contained in the at least one response message. Particularly in the case of an embodiment of the request message explained in further detail below, said storage is performed using valid parameters, so as to create an analysis based on a comparison between the contents of the response message and the contents of the request message.

One advantageous embodiment of the invention relates to an embodiment of the request message having valid parameters such as a correct signature, certificate, time stamp, etc. The first network element responsible for checking is authorized to send such requests, and expects a correspondingly correct response. The network element being checked sees this request message as correct and creates a correspondingly correct response. In the case of a simulated request for a chargeable service, the service has to be billed. The checking network element checks for correct billing by having it confirmed by a collection point or billing point. If the first network element does not receive a valid response message or, in the case of a simulated request for a chargeable service, receives no confirmation from the billing point, it is highly probable that the peer-to-peer software of the checked second network element has been manipulated. In this case the result of the analysis is negative. If data transfer within the network is unreliable and messages (UDP packets etc.) can be lost, this check is repeated as necessary.

An advantageous embodiment of the invention relates to an embodiment of the request message having invalid or incorrect parameters. Incorrect parameters are for example an expired and/or revoked and/or invalid certificate, or a certificate issued by another certification authority that is unrecognized within the decentralized network. Further incorrect parameters are a false request signature, an outdated request with an expired time stamp, etc.

A correctly operating network element using unmanipulated peer-to-peer software must refuse to respond to invalid request messages of this kind. If the request is nonetheless answered, a network element using manipulated peer-to-peer software has been found. However, if there is no response to the request, the checking first network element also tests whether an alarm message from the tested network element arrives at a collection point of the kind known for example as a logging system. In the same way, the non-arrival of such an alarm message can indicate manipulated peer-to-peer software. Here too, provision can be made for this test to be repeated as necessary, in case messages can be lost.

An exemplary embodiment having further advantages and embodiments of the invention will be explained below in greater detail with the aid of the attached drawing.

The FIGURE is a block diagram schematically illustrating a decentralized network.

A decentralized network P2P includes a first network element PX together with two further network elements P1, P2. Each of said network elements P1, P2, PX holds a certificate C1, C2, CX. In this case, for the purpose of checking, the certificate CX held by the first network element PX can be adjusted or modified.

A first and a second collection point SV1, SV2 are either arranged as shown, outside of the decentralized network P2P, or else within the decentralized network P2P (not shown).

It is assumed that the network element P1 requiring to be checked will be tested by means of a correct request message VRQ (valid request) sent by the checking network element PX. The simulated request message is provided with a valid signature, a valid certificate CX, a current time stamp, etc.

In this case, where it is assumed that the network element P1 being checked is operating correctly, a valid response message VRP (valid response) subsequently reaches the checking network element PX. The checking network element PX tests by means of a request REQ to a centralized billing point SV1 whether the service requested by the network element under test has been correctly billed. If a response RSP arrives from the billing point SV1 showing correct billing, the result of the analysis is positive in respect of the network element C1 being tested. The analysis result is optionally transmitted to a collection point (not shown).

It will now be assumed that a further network element P2 requiring to be checked will be tested by means of an incorrect or invalid request message IRQ (invalid request) sent by the checking network element PX. The simulated request message IRQ contains for example an expired and/or revoked and/or invalid certificate CX, or a certificate CX issued by another certification authority that is not recognized within the decentralized network. Further incorrect parameters are a false request signature, an outdated request with an expired time stamp, etc. A correctly operating network element using unmanipulated peer-to-peer software should refuse a positive response to the invalid request message IRQ.

In the present case let it be assumed that manipulated peer-to-peer software is being run on the network element P2 being tested, and so the invalid request message IRQ is nonetheless answered by a response message IRP (invalid response). The analysis result is therefore negative and is optionally transmitted to a collection point (not shown).

If no invalid response message arrives, the checking first network element PX also tests whether an alarm message from the tested network element arrives at a collection point of the kind known for example as a logging system. As before, the non-arrival of such an alarm message indicates manipulated peer-to-peer software.

Using the inventive method, it is possible to test all network elements or peers P1, P2 in the network P2P by random sampling. The greater the proportion of manipulated peers P2, the faster they will be detected. If there are very few manipulated peers P2, there is a very low probability of discovering them, but said peers P2 then cause less damage and, depending on the policy of the network administration, can be tolerated for a short while.

1.-15. (canceled)

16. A method for checking network elements in a decentralized network, comprising:
selecting a second network element by a first network element to check the second network element;
defining parameters for an assignment to a request message;
transmitting the request message to the second network element; and
analyzing a response message, wherein the response message answers the request message.

17. The method as claimed in claim 16, wherein at least a first part of the network elements provides at least temporarily a service for at least a second part of the network elements.

18. The method as claimed in claim 16, wherein the parameters are stored in the first network element, and wherein the analysis of the response message is based upon the parameters stored in the first network element and based upon further parameters contained in the response message.

19. The method as claimed in claim 16, wherein the response message is received at the first network element.

20. The method as claimed in claim 16, wherein a collection point in the decentralized network receives the response message.

21. The method as claimed in claim 20, wherein the collection point receives data selected from the group consisting of:
a warning message,
a billing information,
a certificate data, and a combination thereof.

22. The method as claimed in claim 16, wherein the parameters assigned to the request message are defined to create a valid request message.

23. The method as claimed in claim 22, wherein the parameters contain a valid signature, a valid certificate and a valid time stamp.

24. The method as claimed in claim 22, wherein an arrival of a valid response message from the second network element is checked by a billing point.

25. The method as claimed in claim 23, wherein an arrival of a valid response message showing correct billing is checked by a billing point.

26. The method as claimed in claim 22, wherein an arrival of a valid response message is checked, and wherein a result of the check is analyzed and sent to a collection point.

27. The method as claimed in claim 16, wherein the parameters for the assignment to the request message are defined to create an invalid request message.

28. The method as claimed in claim 27, wherein the parameters contain an invalid data selected from the group consisting of a invalid signature, an invalid certificate, an invalid time stamp, and a combination thereof.

29. The method as claimed in claim 27, wherein an arrival of a response message from the second network element is checked by a billing point.

30. The method as claimed in claim 27, wherein an arrival of a response message showing correct billing is checked by a billing point.

31. The method as claimed in claim 26, wherein the result of the check is analyzed and sent to a collection point.

32. A network element for checking network elements in a decentralized network, comprising:
a connection to the network, wherein the network element selects a second network element to check the second network element;
a transmitting device to transmit a request message to the second network element, wherein parameters for an assignment to a request message are defined by the network element; and
a analyzing device to analyze a response message, wherein the response message answers the request message.

33. The network as claimed in claim 32, wherein an arrival of a valid response message is checked, and wherein a result of the check is analyzed and sent to a collection point.
